(19) United States
(12) Patent Application Publication
(10) Pub. No.: US 2012/0292548 A1
(43) Pub. Date: Nov. 22, 2012

(54) Motorized rotary valve

(76) Inventors: Yuriy Ogol, Karlsruhe (DE); Claus Hanebeck, Rheinstetten (DE); Gerhard Roth, Rheinstetten (DE)

(21) Appl. No.: 13/575,306

(22) PCT Filed: Jan. 31, 2011
(86) PCT No.: PCT/EP11/51313

§ 371 Date: Jul. 26, 2012

(30) Foreign Application Priority Data
Feb. 2, 2010 (DE) 10 2010 001 498.2

(51) Int. Cl. F16K 11/074; F16K 31/04

(52) U.S. Cl. 251/309; 251/129.11

(57) ABSTRACT

A rotary valve (1) for a cryocooler, in particular for a pulse tube cooler or for a Gifford-Mc-Mahon cooler, has a rotary body (6) that can be rotated by a motor about a rotary axis (DA), a control plate (5), and an axial rolling bearing, by means of which the rotary body (6) can roll along the control plate (5). The axial roller bearing is designed (19a-19c) as a bearing that is non-centering in the radial direction (RR). The rotary valve for a cryocooler has low wear and is thereby simple to produce and assemble.

The invention concerns a rotary valve for a cryocooler, in particular, for a pulse tube cooler or a Gifford-McMahon cooler, comprising
a rotary body which can be rotated about an axis of rotation by means of a motor,
a control plate,
and an axial rolling bearing by means of which the rotary body can roll along the control plate.

A rotary valve of this type is disclosed e.g. in US 2008/0245077 A1.

Many technical systems must be operated at cryogenic temperatures, e.g. superconducting magnet coils. One principle of generating cold is based on the expansion of a working gas. In case of pulse tube coolers and Gifford-McMahon coolers, a high and a low working gas pressure are alternately applied to a cold head. To this end, in practice, the suction side and the high-pressure side of a compressor are alternately connected to the cold head. A rotary valve is normally used in this connection.

The rotary valve comprises a rotary body, which is typically driven by an electromotor, and a control plate. The rotation of the rotary body relative to the control plate alternately opens and closes different flow channels for the working gas, thereby alternately applying a desired high and low pressure to the cold head.

During operation of the rotary valve, a surface or several surfaces of the rotary body slide along one or more surfaces of the control plate. The surfaces seal the working gas in the contact areas. The sliding motion can cause material abrasion, which finally necessitates replacement of the rotary body and/or control plate.

In document US 2008/0245077 A1, the rotary body and the control plate are each provided with a circumferential channel, wherein a ball cage is held between the channels. This ball bearing reduces wear.

This prior art is disadvantageous due to the high production and assembly expense for this ball bearing. The channels must be arranged exactly concentrically with respect to each other, since the balls of the ball cage would otherwise escape from at least one of the channels and the surfaces of the rotary body and control plate would tilt with respect to each other, causing working gas leakage and increased wear on the bearing. For this reason, in practice, most components of the rotary valve, in particular, the rotary body, must be produced from metal and must be milled in order to be able to meet the production tolerances predetermined by the sealing requirements.

### OBJECT OF THE INVENTION

It is the underlying purpose of the present invention to present a rotary valve for a cryocooler, which has little wear and at the same time is easy to produce and mount.

### BRIEF DESCRIPTION OF THE INVENTION

This object is achieved in a surprisingly simple but effective fashion by a rotary valve of the above-mentioned type, which is characterized in that the axial rolling bearing is designed as a bearing that is non-centering in the radial direction.

In an inventive non-centering bearing, the bearing allows the rotary body and the control plate (control disk) to freely slide with respect to each other within a certain area in the radial direction (i.e. in the plane perpendicular to the axis of rotation of the rotary body). In this case, it is irrelevant whether the rotary body and the control plate deviate slightly from exact concentric alignment with respect to the axis of rotation of the rotary body in the mounted state due to tolerances or errors during production and/or assembly. The sealing effect on the mutual sliding surfaces is maintained. For this reason, components that are simple to produce can be used in connection with the rotary valve within the scope of the invention, i.e. a rotary body which is produced from plastic material using inexpensive injection molding technology and has relatively large production tolerances.

For setting up a non-centering bearing, flat bearing surfaces, which are disposed opposite to each other and parallel to each other, are typically formed on the rotary body and on the control plate, between which rolling bodies (e.g. balls or preferably circular cylinders) are arranged, e.g. held in a cage. The flat bearing surfaces prevent centering in the radial direction (perpendicularly to the axis of rotation of the rotary body). The bearing surfaces are typically formed in a circular shape, e.g. on bearing disks mounted to the rotary body and to the control plate. It should be noted that the bearing surfaces are aligned perpendicularly with respect to the axis of rotation of the rotary body.

Recesses (milled-out portions, openings, channels) are provided in the control plate and in the rotary body. The overlapping of the recesses varies during rotation of the rotary body, thereby alternately connecting a high and a low working gas pressure (e.g. helium) to the cold head (e.g. a pulse tube). When the recesses have a suitable design, the play in the radial orientation of the rotary body and the control plate does not influence the switching behavior of the rotary valve (see below).

The rotary body is typically driven by means of an electromotor. A rolling bearing may be, in particular, a ball bearing or a cylindrical roller bearing.

### PREFERRED EMBODIMENTS OF THE INVENTION

In one preferred embodiment of the inventive rotary valve, the axial rolling bearing is designed as a cylindrical roller bearing. The (circular) cylindrical rollers are suitable for accepting large forces, and the bearing surfaces remain flat even after longer periods of stress such that the non-centering property of the bearing is maintained during use even when the bearing surfaces are made from a material that is less wear resistant. Cylindrical rollers also enable a comparatively flat design. In this embodiment, the cylinder axes are normally oriented in parallel with the bearing surfaces and are directed towards the axis of rotation of the rotary body. In other words, the cylinder axes are (approximately) perpendicular to the axis of rotation of the rotary body.

In one preferred further development of this embodiment, the cylindrical roller bearing is designed as a needle bearing. The needle bearing has a particularly flat structure.

In one particularly advantageous embodiment, a recess for working gas in the control plate extends in a radial direction entirely within a communicating recess for working gas in the rotary body or vice versa. In the converse case, a recess for working gas in the rotary body extends in a radial direction entirely within one communicating recess for working gas in the control plate. With this orientation, slight radial false centering, e.g. due to production tolerances, does not influence the flow behavior of the working gas. The edge spacing of the recesses in the radial direction is typically considerably larger than the radial play to be expected. The play is typically within a range of up to 0.2 mm or less.

In another preferred embodiment, a spring presses the rotary body against the control plate. The spring holds a bearing that is not self-retaining even when no working gas pressure is applied. The rotary body is thereby typically seated on a shaft of an electromotor such that it can move in an axial direction.

In one particularly preferred embodiment, the rotary body is produced from plastic material, in particular through injection molding. This considerably reduces the production costs of the inventive rotary valve.

In another preferred embodiment, the bearing surfaces of the axial rolling bearing on the control plate and on the rotary body are separate from the sealing surface or sealing surfaces between the control plate and the rotary body. In this case, any possible bearing abrasion does not influence the sealing behavior.

Further advantages of the invention can be extracted from the description and the drawing. The features mentioned above and below may be used in accordance with the invention either individually or collectively in arbitrary combination. The embodiments illustrated and described are not to be understood as exhaustive enumeration but have exemplary character for describing the invention.

### DETAILED DESCRIPTION OF THE INVENTION AND THE DRAWING

The invention is illustrated in the drawing and is explained in more detail with reference to embodiments. In the drawing:

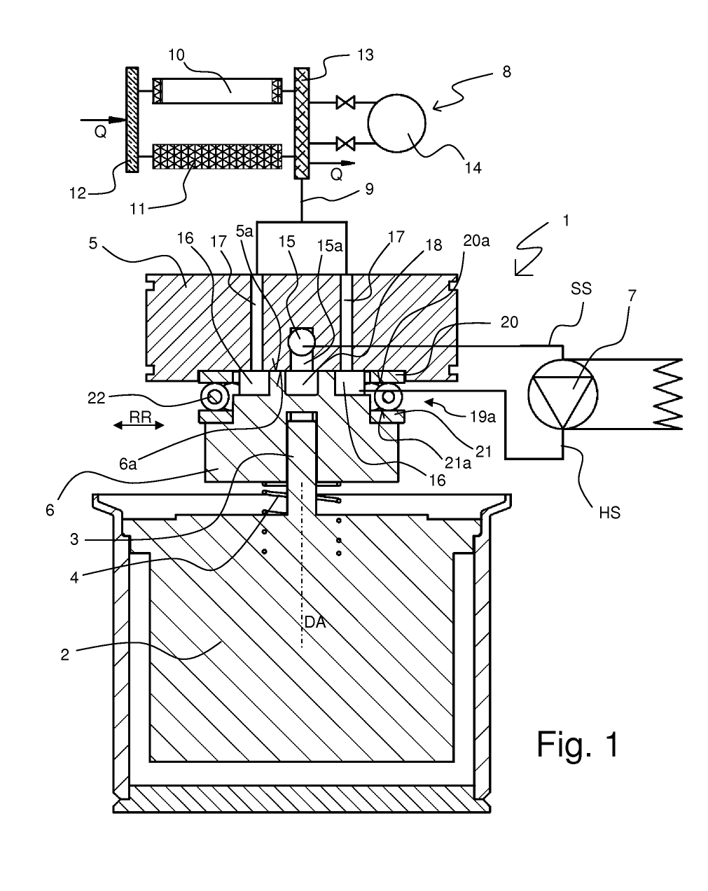

FIG. 1 shows a schematic view of a cooling system with a pulse tube cooler, comprising an inventive rotary valve illustrated in an axial sectional view;

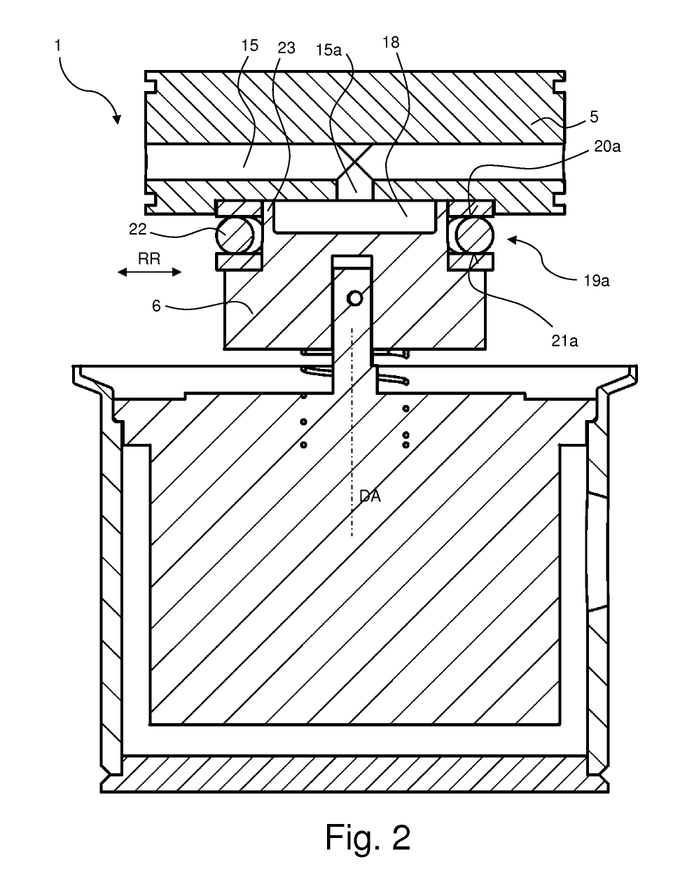

FIG. 2 shows an axial sectional view through an inventive rotary valve including motor with ball bearing;

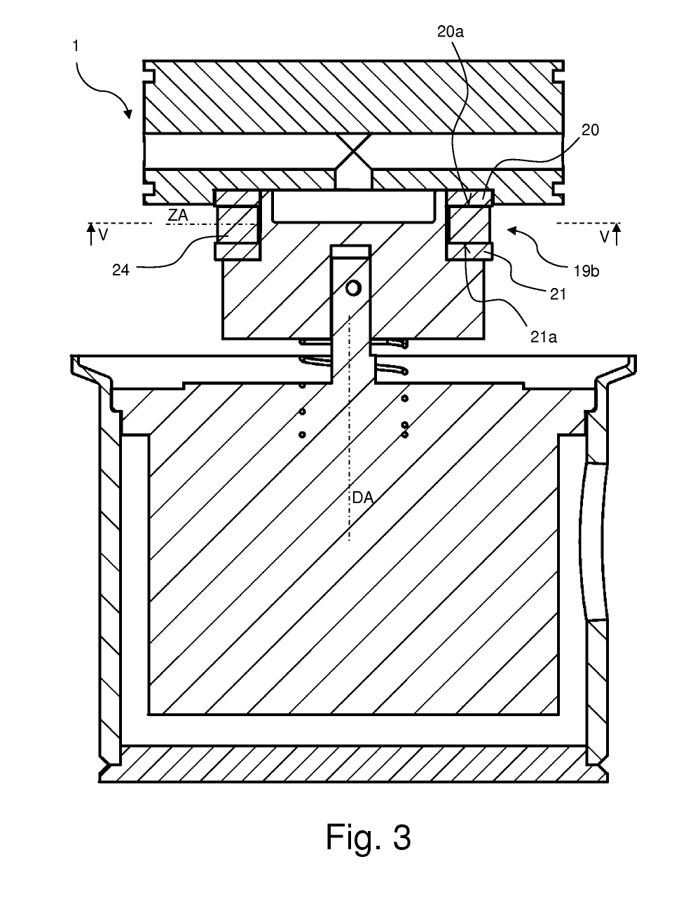

FIG. 3 shows an axial sectional view through an inventive rotary valve including motor with a cylindrical roller bearing;

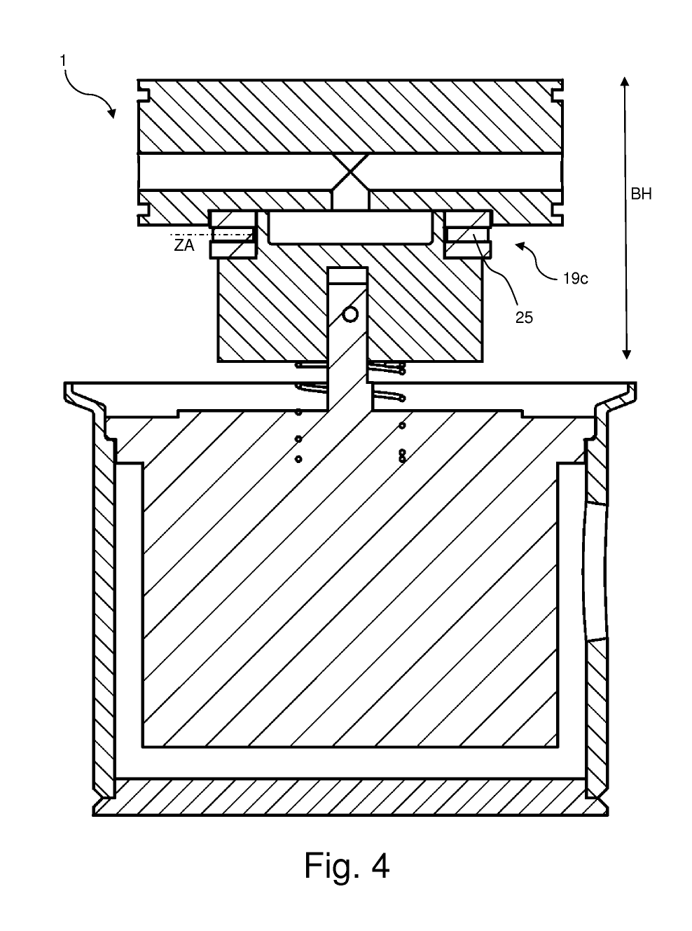

FIG. 4 shows an axial sectional view through an inventive rotary valve including motor with a needle bearing;

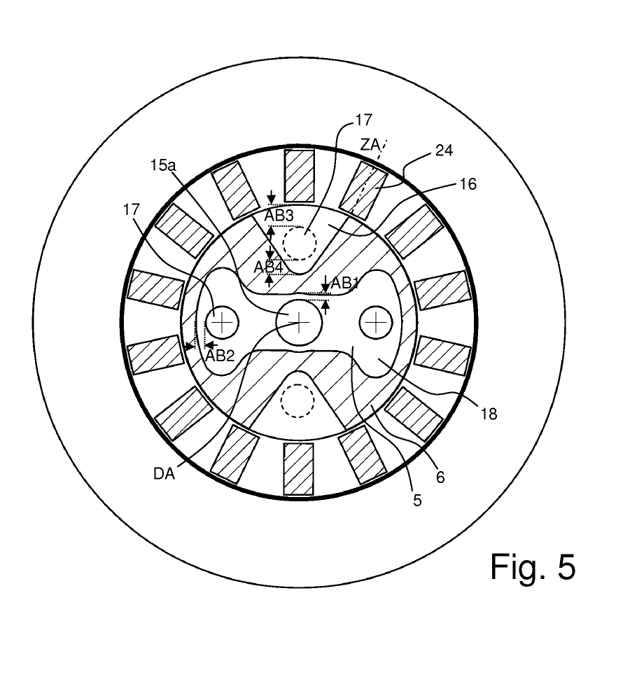

FIG. 5 shows a radial sectional view through the rotary valve of FIG. 3 at the level of line V in FIG. 3.

FIG. 1 shows an overview of a cooling system which can be used within the scope of the present invention.

The cooling system comprises an inventive rotary valve 1 with a rotary body 6 and a control plate (control disk) 5. The rotary body 6 can be rotated relative to the control plate 5 by means of an electronnotor 2. The rotary body 6 thereby rotates about an axis of rotation DA. The rotary body 6 is held on a shaft 3 of the electronnotor 2, such that it cannot rotate therewith but can freely slide on the shaft 3 in an axial direction (parallel to the axis of rotation DA of the rotary body). A spring 4 presses the rotary body 6 against the control plate 5 even in the absence of a working gas pressure.

A high-pressure side HS and a suction side SS are alternately connected to a cold head 8 or its working gas inlet 9 using a compressor 7. The cold head 8 is designed as a pulse tube cooler in the present case, comprising a pulse tube 10, a regenerator tube 11, a cold heat exchanger area 12 (cf. thermal flow Q), a warm heat exchanger area 13 that is cooled by the external air, and a buffer volume 14.

The rotary body 6 and the control plate 5 have various recesses (milled-out portions, openings, channels) for controlling the flow or the pressure of the working gas (in the present case helium). The suction side SS (also called low-pressure side) is connected to a central bore 15a of the control plate 5 via a channel 15. The high-pressure side HS is connected to the surroundings of the rotary body 6 such that the pressure of the working gas forces the rotary body 6 (in addition to the spring 4) against the control plate 5, but also enables working gas to enter at a high pressure into laterally open recesses 16 of the rotary body 6 and reach the inlet 9 of the cold head 8 via two acentric channels 17 (it should be noted that a pressure housing for the rotary valve 1, which seals, in particular, the space on the side of the rotary body 6, is not illustrated in FIG. 1 for reasons of simplicity). The suction side SS can be connected to the channels 17 using a central recess 18 in the rotary body by rotating the rotary body through 90° about the axis DA (FIG. 5).

The rotary body 6 is supported in two areas of the control plate 5. The surfaces 5a of the control plate 5 and 6a of the rotary body 6, which seal the working gas, abut each other. Each surface 5a extends perpendicularly with respect to the axis of rotation DA. A non-centering bearing 19a is also provided.

One annular bearing disk 20, 21 of a wear-resistant material, e.g. hardened metal or ceramic material such as SiC, is mounted to each of control plate 5 and rotary body 6. The parallel flat surfaces 20a, 21a of the bearing disks face each other. A cage with balls 22 is provided between these surfaces 20a, 21a. Since the surfaces 20a, 21a do not form a channel (in contrast to conventional ball bearings of prior art), but extend flatly and parallel with respect to the radial direction RR, the rotary body 6 has a certain amount of radial play, which does not impair the sealing effect on the surfaces 5a, 6a. In particular, the rotary body 6 and the control plate 5 are not tilted with respect to each other when the rotary body 6 and the control plate 5 are slightly shifted with respect to each other in the radial direction RR. Moreover, the overlappings of the recesses/channels 15a, 16, 17, 18 are not impaired either (see in this connection also FIG. 5).

For this reason, the non-centering bearing allows larger tolerances for the relative radial orientation of rotary body and control pate. In particular, the production and mounting methods of the rotary body can be facilitated and the cost can be reduced. In the present case, the rotary body 6 was produced from a plastic material (e.g. polyethylene) using an injection molding method.

After assembly of the rotary valve 1, typically only the sealing surface 6a of the rotary body 6 initially abuts the control plate 5 (not via the bearing 19a). The projection, however, is quickly reduced due to abrasion under the action of the spring 4 and, where applicable, the working gas pressure until the bearing 19a also holds the rotary body 6, which quickly happens, in particular, when plastic material is used on the sealing surface 6a. The rotary body 6 is then perfectly fitted and the bearing 19a prevents further abrasion on the sealing surface 6a.

FIGS. 2, 3 and 4 each show different feasible designs of the bearing of the rotary valve 1 in more detail. Only the differences with respect to FIG. 1 are explained below.

FIG. 2 shows the rotary valve of FIG. 1 with non-centering ball bearing 19a, however, in a vertical sectional plane which is rotated through 90° about the axis of rotation DA of the rotary body 6. The channel 15 and the recess 18 are now illustrated in their respective longitudinal sectional view. The suction side SS (which is connected to the channel 15) is not connected to the inlet of the cold head, which is also illustrated in FIG. 1. A web 23 seals the outer area of the rotary body 6 (where a high working gas pressure is always applied and where the balls 22 are located) from the recess 18. It should be noted that the balls 22 move on bearing surfaces 20a, 21a, which are flat along the radial direction RR.

The non-centering bearing 19b of FIG. 3 has cylindrical rollers 24 which roll along the flat parallel oppositely arranged surfaces 20a, 21a of the bearing disks 20, 21. The cylinder axes ZA are directed to the axis of rotation DA of the rotary body 6 and extend perpendicularly to the axis of rotation DA. The bearing surfaces 20a, 21a are flatly abraded during use to prevent formation of a channel in case the bearing disks 20, 21 are made from a material having a low abrasion resistance.

FIG. 4 shows the non-centering bearing 19c designed with cylindrical rollers 25 having a particularly small diameter. In this case, the bearing 19c is also called “needle bearing”. The use of a needle bearing 19c reduces the height BH of the rotary valve 1 in an axial direction.

FIG. 5 shows a cross-section through the bearing 19b of FIG. 3 at line V there, however, with the position of the rotary body 6 being rotated through 90° (solid lines) and additionally indicated in the position of FIG. 3 (dotted lines).

The cross-sectional view shows the (circular) cylindrical rollers 24, by means of which the rotary body 6 and the control plate 5 roll along each other in the bearing 19b.

In the position illustrated by solid lines, the central recess 18 of the rotary body 6 connects the channels 17, which terminate at the lower side of the control plate 5, to the central bore 15a, which is connected to the suction side of the compressor.

In the relative orientation of the rotary body 6 and the control plate 5, which is indicated by dotted lines, the channels 17 are connected to the high-pressure side of the compressor (see also FIG. 1) via the laterally open recesses 16 of the rotary body 6.

With respect to their radial extension, the openings of the channels 17 are located entirely within the central recess 18 and also entirely within the laterally open recesses 16. The radial extension of the central recess 15a is also entirely within the central recess 18. FIG. 5 shows an exactly concentric orientation of rotary body 6 and control plate 5, in which the edges are considerably spaced apart AB1, AB2, AB3, AB4 in the radial direction with respect to all communicating recesses (milled-out portions, openings, channels). The smallest edge spacing in a concentric orientation, in the present case AB1 of the central recesses 15a and 18, is sufficiently large in accordance with the invention such that the maximum production and mounting tolerance to be expected with respect to a radial misfit of rotary body 6 and control plate 5 is smaller than the above-mentioned smallest edge spacing AB1. The flow or pressure distribution of the working gas is then not impaired by the radial misfit.

1-7. (canceled)

8. A rotary valve for a cryocooler, a pulse tube cooler or a Gifford-McMahon cooler, the rotary valve comprising:
a rotary body, said rotary body structured for rotation, by means of a motor, about an axis of rotation;
a control plate; and
an axial rolling bearing cooperating with said rotary body and said control plate to facilitate rolling of said rotary bearing along said control plate, wherein said axial rolling bearing is non-centering in a radial direction.

9. The rotary valve of claim 8, wherein said axial rolling bearing is designed as a cylindrical roller bearing.

10. The rotary valve of claim 9, wherein said cylindrical roller bearing is designed as a needle bearing.

11. The rotary valve of claim 8, wherein said control plate has a recess for working gas, said recess extending in a radial direction entirely within a communicating recess for working gas in said rotary body.

12. The rotary valve of claim 8, wherein said rotary body has a recess for working gas, said recess extending in a radial direction entirely within a communicating recess for working gas in said control plate.

13. The rotary valve of claim 8, wherein said rotary body is pressed against said control plate by a spring.

14. The rotary valve of claim 8, wherein said rotary body is produced from plastic material.

15. The rotary valve of claim 14, wherein said rotary body is produced by injection molding.

16. The rotary valve of claim 8, wherein bearing surfaces of said axial rolling bearing at said control plate and at said rotary body are separate from a sealing surface or sealing surfaces between said control plate and said rotary body.
